(19) United States
(12) Patent Application Publication
(10) Pub. No.: US 2026/0006575 A1
(43) Pub. Date: Jan. 1, 2026

(54) POSITIONING ENHANCEMENTS FOR THE NEXT GENERATION RADIO ACCESS NETWORK WITH SERVICE BASED INTERFACES

(71) Applicant: Intel Corporation, Santa Clara, CA (US)

(72) Inventors: Zongrui Ding, Portland, OR (US); Sudeep Palat, Cheltenham (GB); Qian Li, Portland, OR (US); Alexandre Saso Stojanovski, Paris (FR); Thomas Luetzenkirchen, Taufkirchen (DE); Abhijeet Kolekar, Leander, TX (US); Xiaopeng Tong, Beijing (CN); Richard Burbidge, Shrivenham (GB); Puneet Jain, Portland, OR (US)

(21) Appl. No.: 19/058,766

(22) Filed: Feb. 20, 2025

Related U.S. Application Data
(60) Provisional application No. 63/556,786, filed on Feb. 22, 2024.

(51) Int. Cl. H04W 64/00; H04W 4/029; H04W 76/20

(52) U.S. Cl. CPC H04W 64/00; H04W 4/029; H04W 76/20

(57) ABSTRACT

Various embodiments herein relate to a location service (LCS) procedure of a user equipment (UE). The UE may be configured to generate a message for transmission to a location mobility function (LMF) of a cellular network, wherein the message is related to the LCS procedure. The UE may further be configured to address the message to the LMF. The UE may further be configured to encode the message for transmission to a distributed unit (DU) of the cellular network, wherein the DU is configured to forward the message to the LMF. Other embodiments may be described and/or claimed.

### CROSS REFERENCE TO RELATED APPLICATION

The present application claims priority to U.S. Provisional Patent Application No. 63/556,786, which was filed Feb. 22, 2024, the disclosure of which is hereby incorporated by reference.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a converged radio access network (RAN)/core network (CN) reference architecture with a RAN service based architecture (SBA), in accordance with various embodiments.

FIG. 2 illustrates an example of a separate RAN/CN reference architecture with a RAN SBA, in accordance with various embodiments.

FIG. 3 illustrates an example of location service support by a next generation RAN (NG-RAN), in accordance with various embodiments.

FIG. 4 illustrates an example protocol stack for long term evolution (LTE) positioning protocol (collectively, “LPP”), in accordance with various embodiments.

FIG. 5 illustrates an example protocol stack for NR positioning protocol A (NRPPa) between a NG-RAN and a location management function (LMF), in accordance with various embodiments.

FIG. 6 illustrates an example of location service support by NG-RAN nodes with RAN SBA, in accordance with various embodiments.

FIG. 7 illustrates an example of a protocol stack for LPP support using a distributed unit (DU) as a relay, in accordance with various embodiments.

FIG. 8 depicts an example of downlink (DL) LPP message transfer via the DU, in accordance with various embodiments.

FIG. 9 illustrates an example of a protocol stack for LPP support using a DU as a relay via a radio configuration manager (RCM), in accordance with various embodiments.

FIG. 10 illustrates an example of LPP message transfer using a DU as a relay via RCM, in accordance with various embodiments.

FIG. 11 illustrates an example of a protocol stack where an NRPPa protocol data unit (PDU) is carried in a hypertext transfer protocol (HTTP) message, in accordance with various embodiments.

FIG. 12 depicts an example message flow to support NRPPa between a DU and an LMF via RCM, in accordance with various embodiments.

FIG. 13 depicts an example of a protocol stack related to support of NRPPa messages between an LMF and a DU via an RCM, in accordance with various embodiments.

FIG. 14 illustrates an exchange message flow exchange related to the protocol stack of FIG. 13, in accordance with various embodiments.

FIG. 15 illustrates an example message exchange for non-UE-specific NRPPa, in accordance with various embodiments.

FIG. 16 schematically illustrates a cellular network in accordance with various embodiments.

FIG. 17 schematically illustrates components of a cellular network in accordance with various embodiments.

FIG. 18 is a block diagram illustrating components, according to some example embodiments, able to read instructions from a machine-readable or computer-readable medium (e.g., a non-transitory machine-readable storage medium) and perform any one or more of the methodologies discussed herein.

FIG. 19 illustrates a network in accordance with various embodiments.

FIG. 20 depicts an example procedure for practicing the various embodiments discussed herein.

FIG. 21 depicts an alternative example procedure for practicing the various embodiments discussed herein.

FIG. 22 depicts an alternative example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). Unless used differently herein, terms, definitions, and abbreviations may be consistent with terms, definitions, and abbreviations defined in the third generation partnership project (3GPP) technical report (TR) 21.905 v16.0.0 (2019-06).

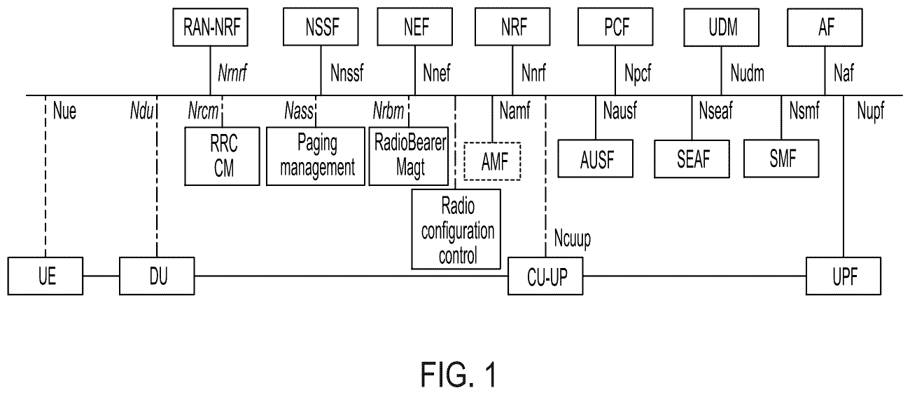

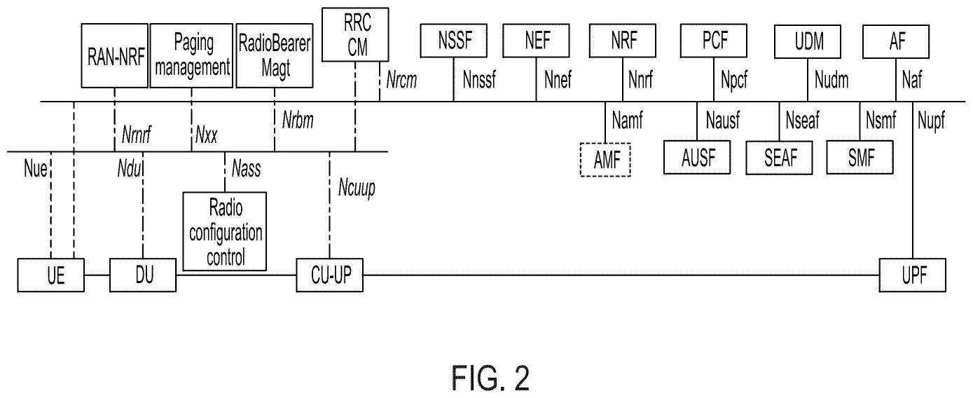

RAN with SBA, as may be implemented in the third generation partnership project (3GPP) release-15 (rel-15) specifications and beyond, may allow for further split of RAN functions, especially radio resource control (RRC) functions, as compared to previous networks. The following describes two possible options for the RAN SBA: 1) a converged architecture, an example of which is shown in FIGS. 1; and 2) a separate architecture, an example of which is shown in FIG. 2.

The RAN SBA may enable simplifying the communication between RAN and CN functions, as they may be connected by a common bus or via radio control management (RCM). As used herein, RCM may refer to a distributed RRC function that may perform one or more administrative aspects of RRC.

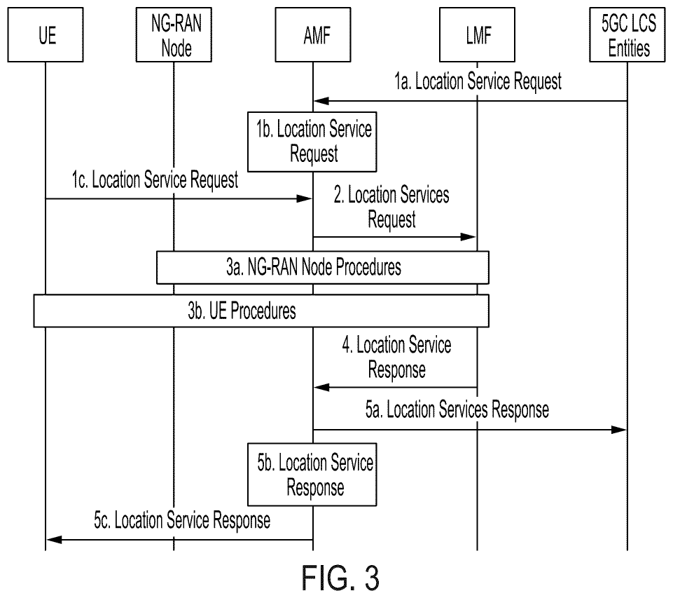

An example of an overall location service (LCS) service procedure is depicted in FIG. 3.

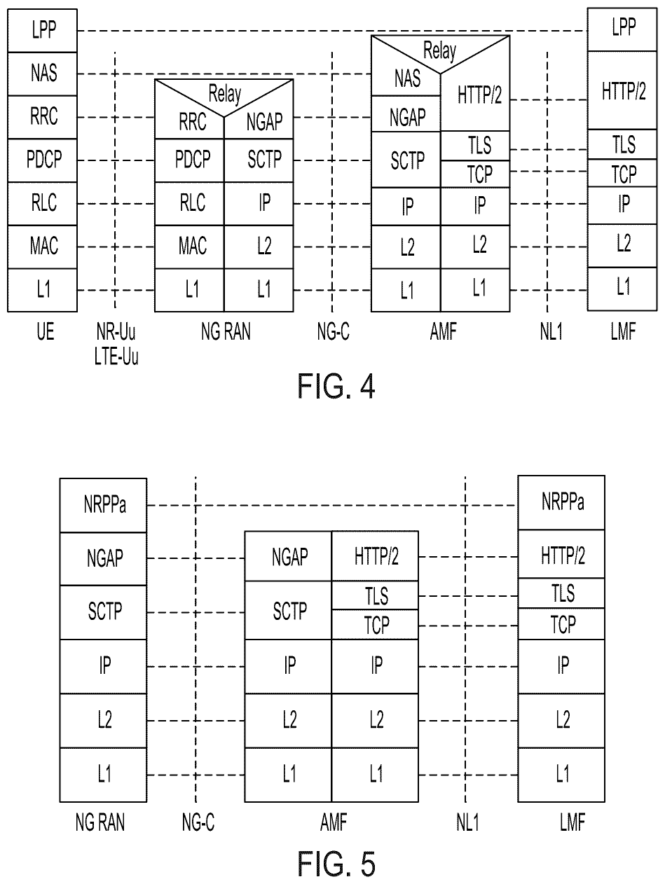

As shown in Element 3b of FIG. 3, positioning related message(s) may be exchanged between a user equipment (UE) and a location management function (LMF) using long term evolution (LTE) positioning protocol (collectively, LPP). In Element 3a of FIG. 3, positioning related message can be exchanged between a RAN node and a LMF using new radio (NR) positioning protocol a (collectively, NRPPa). The LPP uses non-access stratum (NAS) as the transport always going through the access & mobility management function (AMF), which may be a bottleneck for signaling as shown in the example of FIG. 4.

For NRPPa, there are UE specific messages and non-UE specific messages between the RAN node and the LMF. An example protocol stack for NRPPa is shown in FIG. 5.

With N2 going to a service based interface (SBI), UE-specific next generation (NG) application protocol (NGAP) associations may go away. UE-specific NRPPa messages (e.g., enhanced cell identifier (E-CID) positioning related NRPPa messages) may use NRPPa transport procedures as specified in third generation partnership project (3GPP) technical specification (TS) 38.413. So details to enable UE specific NRPPa messages between RAN node and LMF may be be redesigned.

Embodiments herein may relate to enhancements of positioning with RAN SBA to efficiently support LPP and NRPPa.

In legacy architectures, the LPP may be supported using NAS containers which may always go through the AMF. The messages may be supported using NGAP NRPPa procedures for UE-specific messages. However, if the LPP messages may always go through AMF, this may result in the AMF being a signaling bottleneck. With the N2 SBI in a cloud native environment, the NGAP protocol may no longer be applicable. Both LPP and NRPPa may be supported with many protocol layers, which may not be efficient.

With RAN SBA, the support of LPP message exchange between a UE and the LMF may be enabled using a distributed unit (DU) or a DU combined with a RCM as relays. Similarly, direct message exchange for NRPPa between a DU or other RAN functions can be enabled with or without RCM. These enhancements may potentially reduce the signaling overhead to go through AMF under the assumption of N2 as SBI in a more cloud native environment.

### Example Overall LCS Procedure for Service Discovery and LMF Selection

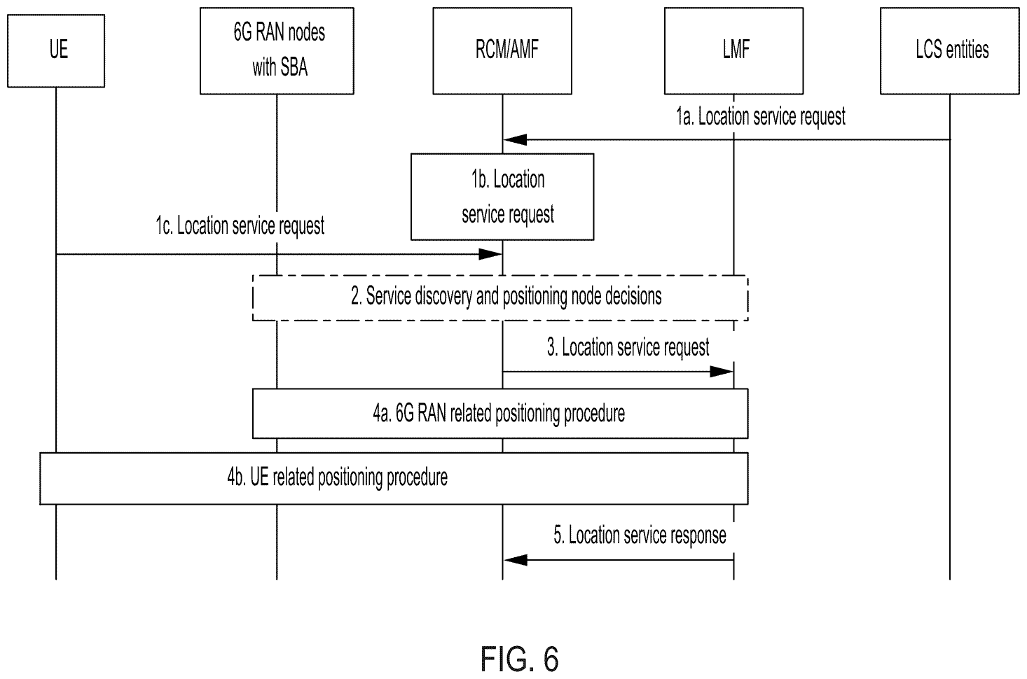

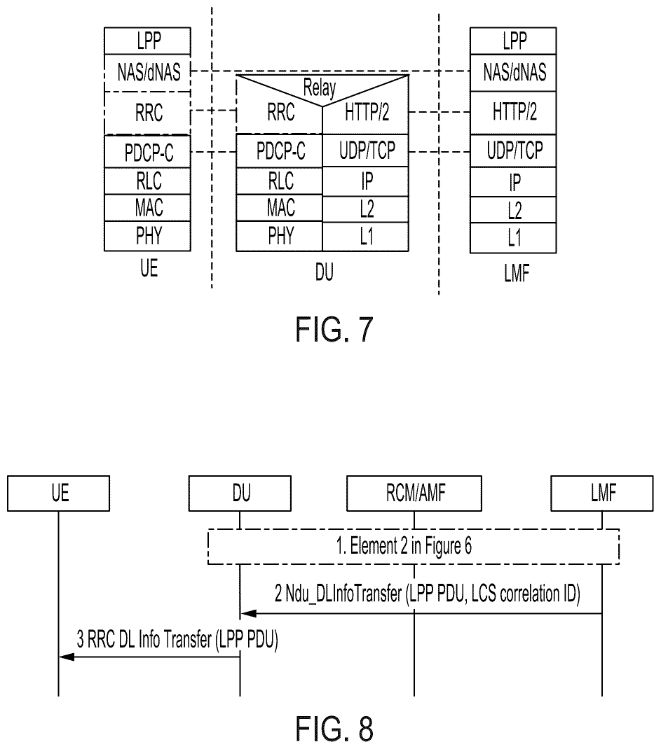

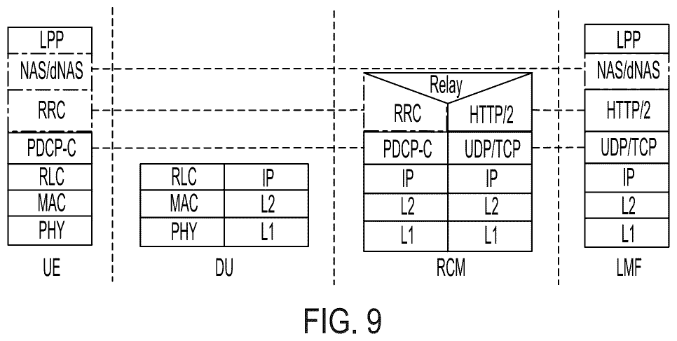

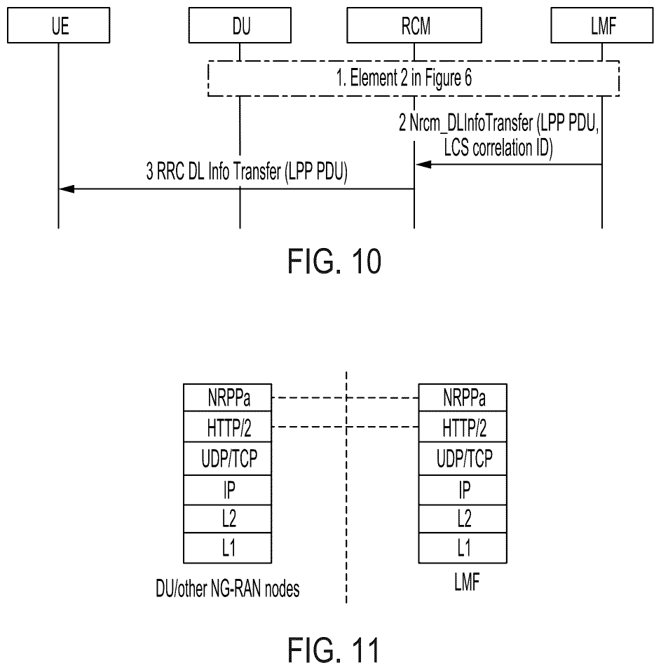

An example overall LCS procedure is shown in FIG. 6 where the Element 2 can have different embodiments to facilitate Elements 4a and 4b as further illustrated below.
Elements 1a, 1b, 1c: the location service requests can come from LCS entities, UE or AMF (e.g., emergency call) similar to the Elements 1a, 1b, and 1c in FIG. 3.
Element 2: Message exchanges for service discovery between AMF/RCM and LMF and sixth generation (6G) RAN functions with SBA and positioning nodes. This includes LMF selection for appropriate LCS services, selection of the RAN nodes such as RAN measurements functions, trigger RAN paging functions to bring UE from RRC_inactive to RRC_connected, identifier generation as part of the context update, DU configuration to forward LPP and NRPPa message for Step 4a and 4b.
Elements 4a and 4b: The 6G RAN node procedures and UE related procedures to provide measurements and get positioning assist information from the network. These message exchange shall be modified based on the 6G RAN architecture with SBA.

### Enhancements to Support LPP

In various embodiments, LPP may be supported using the DU as a relay

As shown in the example of FIG. 7, with the DU and LMF connecting to a common SBI bus in the RAN/CN converged architecture, the DU may be enabled to relay the LPP message directly to LMF. The dashed lines in FIG. 7 show that the NAS/distributed NAS layer and the RRC layer may no longer be necessary.

In various embodiments, the LPP PDU may be supported in one or more of the following ways:
The LPP PDU may be supported in the distributed NAS container between UE and LMF.
The LPP PDU may be supported in the RRC container between UE and DU, then carried by the hypertext transfer protocol (HTTP) message between the DU and the LMF. A new identifier may be used to identify the LPP container from the RRC layer and identify the target LMF, e.g., the LCS correlation identifier (ID) allocated by the LMF or AMF prior to the LPP message exchange.
The LPP PDU may be supported by a specially defined radio bearer directly goes to the packet data convergence protocol (PDCP) container and use the LCS correlation identifier (ID) to be mapped into a hypertext transfer protocol (HTTP) message to the target LMF.

One or more of the above-depicted options may be supported by sending information to UE using the positioningSIB. This may require DU to support PDCP-C and RRC layer. An example of the overall LPP message exchange is shown in FIG. 8, which may be understood as follows:
Element 1: Based on the received LCS request, the RCM/AMF can select an LMF, e.g., based on the network repository function (NRF) inquiries. The RCM/AMF may also decide the UE involved in the positioning procedures such as based on the requested global unique temporary identifier (GUTI) of the UE. The LCS correlation ID can be allocated by LMF or RCM/AMF which will be sent to the DU serving the UE to map the future LPP messages to the target UE. If this step involves network initiated service request procedures, the LCS correlation ID can be sent to the DU during the network initiated service request procedures.
Element 2: LMF sends the LPP PDU in the Ndu_DLInfoTransfer message to the DU. This message shall include the LCS correlation ID to decide the target UE for this LPP message. LMF may also include the positioning routing ID with additional information, for example as may be described or present in 3GPP TS 38.305 to indicate it is a LPP message.
Element 3: The DU sends the LPP PDU in a RRC DL Info Tranfer message to the target UE.
   LPP Supported with DU as a Relay Via RCM

In some embodiments, LPP may be supported with the DU acting as a relay via RCM. In some embodiments, the LMF can exchange LPP messages with UE using both DU and RCM as relays as shown in FIG. 8. In this case, the DU may not be required to have PDCP and RRC layer. The LPP PDU may be supported in one or more of the following ways:
The LPP PDU may be supported in the distributed NAS container between UE and LMF via RCM.
The LPP PDU may be supported in the RRC container between UE and RCM, then carried by the HTTP message between the DU and the LMF. A new identifier is needed to identify the LPP container from the RRC layer and identify the target LMF, e.g., the LCS correlation ID allocated by the LMF or AMF prior to the LPP message exchange.
The LPP packet data unit (PDU) may be supported by a specially defined radio bearer directly goes to the PDCP container and use the LCS correlation ID to be mapped into a HTTP message to the target LMF.

An example LPP message exchange that is related to using the DU as a relay via RCM is illustrated in FIG. 10 as follows:
Element 1: This element may be similar to Element 1 in FIG. 8. However, in this embodiment, the LCS correlation ID may be stored in RCM for future mapping to a target UE.
Element 2: LMF sends the LPP PDU in the Nrcm_DLInfoTransfer with the LCS correlation ID.
Element 3: The RCM sends the LPP PDU in the RRC DL Info Transfer to the target UE.

### Enhancements to Support NRPPa

The RAN related positioning procedure may be between RAN node and the LMF using NRPPa. NRPPa message exchange includes UE specific and non UE specific messages.

The UE specific NRPPa messages can be exchanged between a RAN function and the LMF, specifically between a DU and a LMF, e.g., E-CID procedures. With the N2 being a SBI, the NGAP protocol in FIG. 4 goes away.

The following are two example options to support UE specific NRPPa messages:
Option1: Direct NRPPa messages between LMF and a DU
Option2: NRPPa messages between LMF and a DU via RCM

### Option 1: Support of UE Specific NRPPa Message Between DU and LMF

An example protocol stack is shown in FIG. 11 where the NRPPa PDU is carried in the HTTP message. The DU and LMF are connected via a SBI.

As may be defined 3GPP TS 38.455, the UE specific NRPPa PDUs may need some or all of the following information at the NGAP layer for routing shown in Table 1. The routing ID and Message Type can be reused. But the AMF UE NGAP ID and RAN UE NGAP ID may be used to identify the AMF and the combination of the UE and the RAN node.

TABLE 1
NGAP message to transport UE specific NRPPa PDU

| | | | | | | |
|---|---|---|---|---|---|---|
| | | | IE | | | |
| IE/ | | | type | | | |
| Group | | | and | Semantics | | Assigned |
| Name | Presence | Range | reference | description | Criticality | Criticality |

| | | | | |
|---|---|---|---|---|
| Message Type | M | 9.3.1.1 | YES | ignore |
| AMF UE NGAP | M | 9.3.3.1 | YES | reject |
| ID | | | | |
| RAN UE NGAP | M | 9.3.3.2 | YES | reject |
| ID | | | | |
| Routing ID | M | 9.3.3.13 | YES | reject |
| NRPPa-PDU | M | 9.3.3.14 | YES | reject |

It may be beneficial to replace one or more of the above-depicted identifiers with the identifier to a LMF and the identifier to the combination of the UE and the RAN node, carried in the HTTP message. These identifiers may be referred to herein as “LMF identifier” and “DU+UE identifier.”
In one embodiment, the identifiers for a LMF can be the LMF function ID, and the UE+DU identifier can be the combination of the DU ID and UE ID, e.g., DU ID and inactive radio network temporary identifier (I-RNTI). In another embodiment, the identifiers for a LMF can be the internet protocol (IP) addresses and port numbers for the LMF, the DU ID and UE ID can be the IP address and port number of the DU and the IP address of the UE. In another embodiment, the identifiers for a LMF can be a function ID or IP address and port number, but the DU+UE ID can be the target UE's ID such as an IP address or an I-RNTI. In another embodiment, the identifiers for a LMF can be a uniform resource identifier (URI), and the DU+UE ID can be a URI combination of the DU and the UE. In some embodiments, the DU ID can be a group ID to point to multiple DUs.

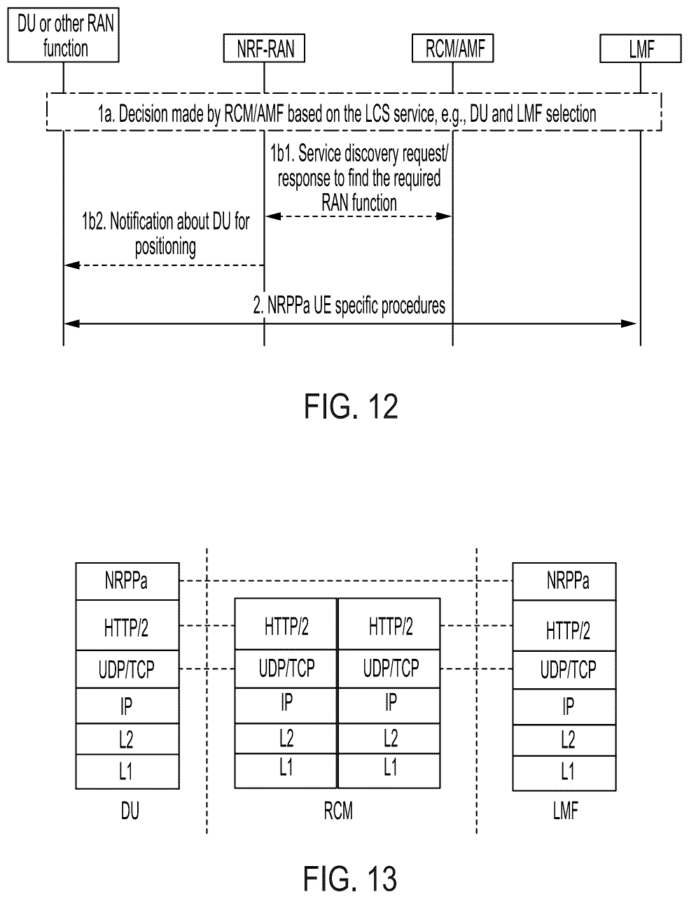

An example message flow may be seen in FIG. 12 and discussed below. The LMF identifier and DU+UE identifier to replace the IDs are shown in italics in Table 1.
Element 1a: The RCM/AMF can select a LMF or DU based on the information related to the LCS request such as the UE's identifier, location information, UE's capabilities, LMF's capabilities, etc. This can include the inquiries of a NRF to select a LMF. This can include to select a DU or multiple DUs. After the LMF and DU selection, the LMF identifier can be sent to the DUs using the Ndu_DLInfoTransfer and the DU+UE identifier can be sent to the LMF using NRF notification message to the LMF respectively. If a UE identifier is present, e.g., a GUTI, it may be mapped to a I-RNTI to be sent to the DU.
Elements 1b1 and 1b2: Alternatively, the RCM/AMF can perform LMF selection similar to Step 1a and query the NRF-RAN to find the DUs. Then the LMF identifier can be sent to the DUs using the notification sent from the NRF-RAN.
Element 2: DU and the LMF can exchange NRPPa messages without RCM.

### Option 2: Support of UE Specific NRPPa Message Between DU and LMF Via RCM

The LMF and DU can also exchange NRPPa messages via RCM as a relay based on the protocol stack as shown in the example of FIG. 13.

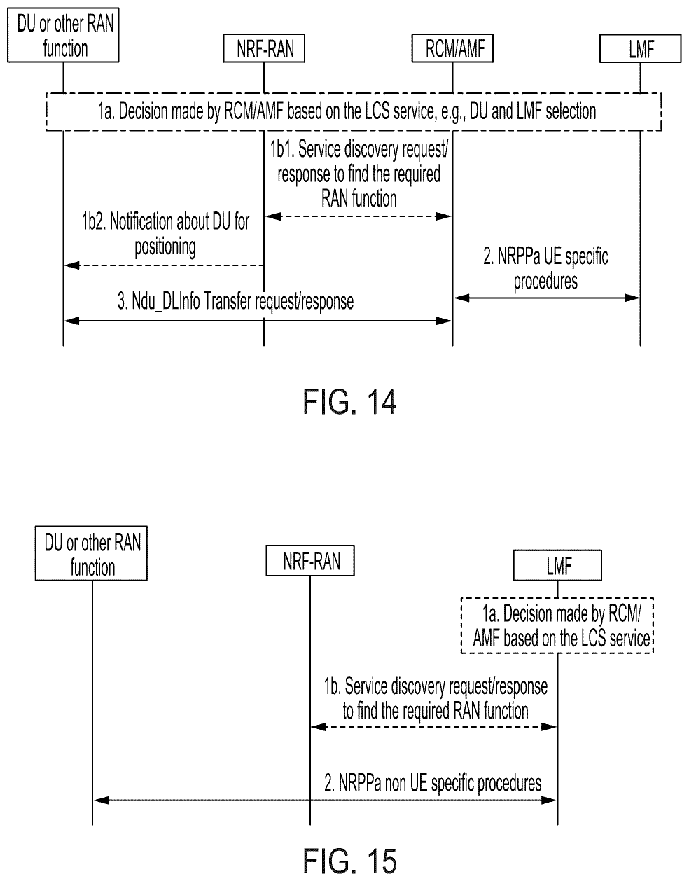

An example of the message exchange flow is shown in FIG. 14 as follows:
Elements 1a, 1b1, 1b2 are similar to Step 1a, 1b1, 1b2 in FIG. 12. The RCM shall be exposed with the LMF ID and the DU+UE ID to route the HTTP message.
Element 2: the NRPPa UE specific messages are exchanged between LMF and RCM where the UE's ID may be mapped from a CN identifier to a RAN identifier, e.g., from a GUTI to I-RNTI
Element 3: the RCM can send the HTTP message with NRPPa PDU to the DU in a Ndu_DLInfoTransfer request message.

### Enhancements to Support UE Non-Specific NRPPa Messages

The non-UE specific NRPPa messages can be carried by the HTTP messages either directly between a RAN function and the LMF using service discovery using an NRF and notification as shown in the example of FIG. 15.
Element 1a: the LMF can be configured with the RAN nodes information by RCM or AMF based on the LCS service request. For example, the LMF can be configured with the RAN function ID or service identifier such as a URI.
Element 1b: The LMF can query the NRF-RAN to find the RAN function based on the RAN function ID or a service identifier configured in Step 1a. Further information can be present such as location, accuracy, measurements with a specific filter.
Element 2: The LMF exchanges non-UE specific NRPPa messages directly with the RAN function. For example, LMF can send specific configurations about the radio and measurements to the DU.

### Systems and Implementations

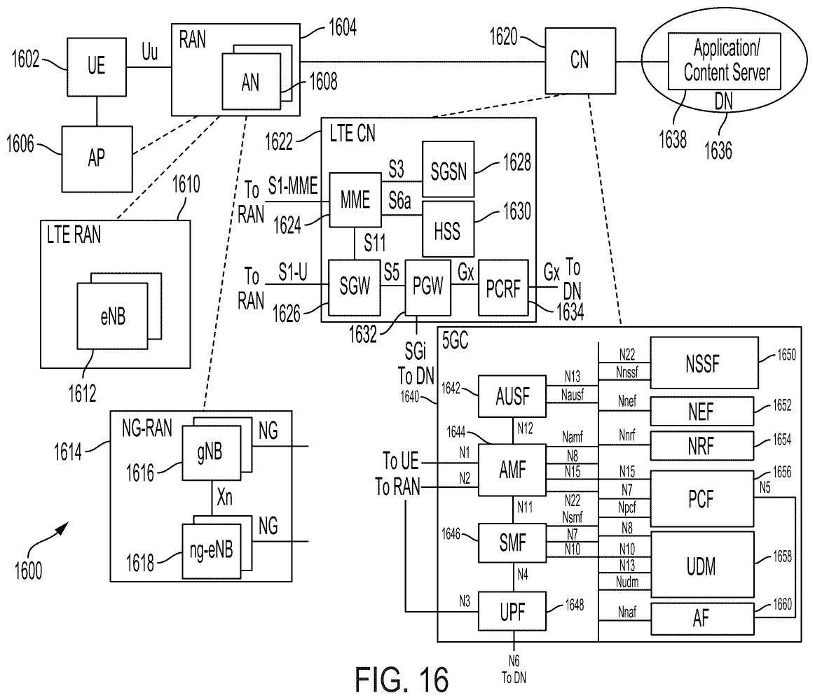

FIGS. 16-19 illustrate various systems, devices, and components that may implement aspects of disclosed embodiments.

FIG. 16 illustrates a network 1600 in accordance with various embodiments. The network 1600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1600 may include a UE 1602, which may include any mobile or non-mobile computing device designed to communicate with a RAN 1604 via an over-the-air connection. The UE 1602 may be communicatively coupled with the RAN 1604 by a Uu interface. The UE 1602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1602 may additionally communicate with an AP 1606 via an over-the-air connection. The AP 1606 may manage a WLAN connection, which may serve to offload some/all network traffic from the RAN 1604. The connection between the UE 1602 and the AP 1606 may be consistent with any IEEE 802.11 protocol, wherein the AP 1606 could be a wireless fidelity (Wi-Fi®) router. In some embodiments, the UE 1602, RAN 1604, and AP 1606 may utilize cellular-WLAN aggregation (for example, LWA/LWIP). Cellular-WLAN aggregation may involve the UE 1602 being configured by the RAN 1604 to utilize both cellular radio resources and WLAN resources.

The RAN 1604 may include one or more access nodes, for example, AN 1608. AN 1608 may terminate air-interface protocols for the UE 1602 by providing access stratum protocols including RRC, PDCP, RLC, MAC, and L1 protocols. In this manner, the AN 1608 may enable data/voice connectivity between CN 1620 and the UE 1602. In some embodiments, the AN 1608 may be implemented in a discrete device or as one or more software entities running on server computers as part of, for example, a virtual network, which may be referred to as a CRAN or virtual baseband unit pool. The AN 1608 be referred to as a BS, gNB, RAN node, eNB, ng-eNB, NodeB, RSU, TRxP, TRP, etc. The AN 1608 may be a macrocell base station or a low power base station for providing femtocells, picocells or other like cells having smaller coverage areas, smaller user capacity, or higher bandwidth compared to macrocells.

In embodiments in which the RAN 1604 includes a plurality of ANs, they may be coupled with one another via an X2 interface (if the RAN 1604 is an LTE RAN) or an Xn interface (if the RAN 1604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1604 may each manage one or more cells, cell groups, component carriers, etc. to provide the UE 1602 with an air interface for network access. The UE 1602 may be simultaneously connected with a plurality of cells provided by the same or different ANs of the RAN 1604. For example, the UE 1602 and RAN 1604 may use carrier aggregation to allow the UE 1602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1602 or AN 1608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1604 may be an LTE RAN 1610 with eNBs, for example, eNB 1612. The LTE RAN 1610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1604 may be an NG-RAN 1614 with gNBs, for example, gNB 1616, or ng-eNBs, for example, ng-eNB 1618. The gNB 1616 may connect with 5G-enabled UEs using a 5G NR interface. The gNB 1616 may connect with a 5G core through an NG interface, which may include an N2 interface or an N3 interface. The ng-eNB 1618 may also connect with the 5G core through an NG interface, but may connect with a UE via an LTE air interface. The gNB 1616 and the ng-eNB 1618 may connect with each other over an Xn interface.

In some embodiments, the NG interface may be split into two parts, an NG user plane (NG-U) interface, which carries traffic data between the nodes of the NG-RAN 1614 and a UPF 1648 (e.g., N3 interface), and an NG control plane (NG-C) interface, which is a signaling interface between the nodes of the NG-RAN1614 and an AMF 1644 (e.g., N2 interface).

The NG-RAN 1614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1602 can be configured with multiple BWPs where each BWP configuration has a different SCS. When a BWP change is indicated to the UE 1602, the SCS of the transmission is changed as well. Another use case example of BWP is related to power saving. In particular, multiple BWPs can be configured for the UE 1602 with different amount of frequency resources (for example, PRBs) to support data transmission under different traffic loading scenarios. A BWP containing a smaller number of PRBs can be used for data transmission with small traffic load while allowing power saving at the UE 1602 and in some cases at the gNB 1616. A BWP containing a larger number of PRBs can be used for scenarios with higher traffic load.

The RAN 1604 is communicatively coupled to CN 1620 that includes network elements to provide various functions to support data and telecommunications services to customers/subscribers (for example, users of UE 1602). The components of the CN 1620 may be implemented in one physical node or separate physical nodes. In some embodiments, NFV may be utilized to virtualize any or all of the functions provided by the network elements of the CN 1620 onto physical compute/storage resources in servers, switches, etc. A logical instantiation of the CN 1620 may be referred to as a network slice, and a logical instantiation of a portion of the CN 1620 may be referred to as a network sub-slice.

In some embodiments, the CN 1620 may be an LTE CN 1622, which may also be referred to as an EPC. The LTE CN 1622 may include MME 1624, SGW 1626, SGSN 1628, HSS 1630, PGW 1632, and PCRF 1634 coupled with one another over interfaces (or “reference points”) as shown. Functions of the elements of the LTE CN 1622 may be briefly introduced as follows.

The MME 1624 may implement mobility management functions to track a current location of the UE 1602 to facilitate paging, bearer activation/deactivation, handovers, gateway selection, authentication, etc.

The SGW 1626 may terminate an SI interface toward the RAN and route data packets between the RAN and the LTE CN 1622. The SGW 1626 may be a local mobility anchor point for inter-RAN node handovers and also may provide an anchor for inter-3GPP mobility. Other responsibilities may include lawful intercept, charging, and some policy enforcement.

The SGSN 1628 may track a location of the UE 1602 and perform security functions and access control. In addition, the SGSN 1628 may perform inter-EPC node signaling for mobility between different RAT networks; PDN and S-GW selection as specified by MME 1624; MME selection for handovers; etc. The S3 reference point between the MME 1624 and the SGSN 1628 may enable user and bearer information exchange for inter-3GPP access network mobility in idle/active states.

The HSS 1630 may include a database for network users, including subscription-related information to support the network entities' handling of communication sessions. The HSS 1630 can provide support for routing/roaming, authentication, authorization, naming/addressing resolution, location dependencies, etc. An S6a reference point between the HSS 1630 and the MME 1624 may enable transfer of subscription and authentication data for authenticating/authorizing user access to the LTE CN 1620.

The PGW 1632 may terminate an SGi interface toward a data network (DN) 1636 that may include an application/content server 1638. The PGW 1632 may route data packets between the LTE CN 1622 and the data network 1636. The PGW 1632 may be coupled with the SGW 1626 by an S5 reference point to facilitate user plane tunneling and tunnel management. The PGW 1632 may further include a node for policy enforcement and charging data collection (for example, PCEF). Additionally, the SGi reference point between the PGW 1632 and the data network 16 36 may be an operator external public, a private PDN, or an intra-operator packet data network, for example, for provision of IMS services. The PGW 1632 may be coupled with a PCRF 1634 via a Gx reference point.

The PCRF 1634 is the policy and charging control element of the LTE CN 1622. The PCRF 1634 may be communicatively coupled to the app/content server 1638 to determine appropriate QoS and charging parameters for service flows. The PCRF 1632 may provision associated rules into a PCEF (via Gx reference point) with appropriate TFT and QCI.

In some embodiments, the CN 1620 may be a 5GC 1640. The 5GC 1640 may include an AUSF 1642, AMF 1644, SMF 1646, UPF 1648, NSSF 1650, NEF 1652, NRF 1654, PCF 1656, UDM 1658, and AF 1660 coupled with one another over interfaces (or “reference points”) as shown. Functions of the elements of the 5GC 1640 may be briefly introduced as follows.

The AUSF 1642 may store data for authentication of UE 1602 and handle authentication-related functionality. The AUSF 1642 may facilitate a common authentication framework for various access types. In addition to communicating with other elements of the 5GC 1640 over reference points as shown, the AUSF 1642 may exhibit an Nausf service-based interface.

The AMF 1644 may allow other functions of the 5GC 1640 to communicate with the UE 1602 and the RAN 1604 and to subscribe to notifications about mobility events with respect to the UE 1602. The AMF 1644 may be responsible for registration management (for example, for registering UE 1602), connection management, reachability management, mobility management, lawful interception of AMF-related events, and access authentication and authorization. The AMF 1644 may provide transport for SM messages between the UE 1602 and the SMF 1646, and act as a transparent proxy for routing SM messages. AMF 1644 may also provide transport for SMS messages between UE 1602 and an SMSF. AMF 1644 may interact with the AUSF 1642 and the UE 1602 to perform various security anchor and context management functions. Furthermore, AMF 1644 may be a termination point of a RAN CP interface, which may include or be an N2 reference point between the RAN 1604 and the AMF 1644; and the AMF 1644 may be a termination point of NAS (N1) signaling, and perform NAS ciphering and integrity protection. AMF 1644 may also support NAS signaling with the UE 1602 over an N3 IWF interface.

The SMF 1646 may be responsible for SM (for example, session establishment, tunnel management between UPF 1648 and AN 1608); UE IP address allocation and management (including optional authorization); selection and control of UP function; configuring traffic steering at UPF 1648 to route traffic to proper destination; termination of interfaces toward policy control functions; controlling part of policy enforcement, charging, and QOS; lawful intercept (for SM events and interface to L1 system); termination of SM parts of NAS messages; downlink data notification; initiating AN specific SM information, sent via AMF 1644 over N2 to AN 1608; and determining SSC mode of a session. SM may refer to management of a PDU session, and a PDU session or “session” may refer to a PDU connectivity service that provides or enables the exchange of PDUs between the UE 1602 and the data network 1636.

The UPF 1648 may act as an anchor point for intra-RAT and inter-RAT mobility, an external PDU session point of interconnect to data network 1636, and a branching point to support multi-homed PDU session. The UPF 1648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1648 may include an uplink classifier to support routing traffic flows to a data network.

The NSSF 1650 may select a set of network slice instances serving the UE 1602. The NSSF 1650 may also determine allowed NSSAI and the mapping to the subscribed S-NSSAIs, if needed. The NSSF 1650 may also determine the AMF set to be used to serve the UE 1602, or a list of candidate AMFs based on a suitable configuration and possibly by querying the NRF 1654. The selection of a set of network slice instances for the UE 1602 may be triggered by the AMF 1644 with which the UE 1602 is registered by interacting with the NSSF 1650, which may lead to a change of AMF. The NSSF 1650 may interact with the AMF 1644 via an N22 reference point; and may communicate with another NSSF in a visited network via an N31 reference point (not shown). Additionally, the NSSF 1650 may exhibit an Nnssf service-based interface.

The NEF 1652 may securely expose services and capabilities provided by 3GPP network functions for third party, internal exposure/re-exposure, AFs (e.g., AF 1660), edge computing or fog computing systems, etc. In such embodiments, the NEF 1652 may authenticate, authorize, or throttle the AFs. NEF 1652 may also translate information exchanged with the AF 1660 and information exchanged with internal network functions. For example, the NEF 1652 may translate between an AF-Service-Identifier and an internal 5GC information. NEF 1652 may also receive information from other NFs based on exposed capabilities of other NFs. This information may be stored at the NEF 1652 as structured data, or at a data storage NF using standardized interfaces. The stored information can then be re-exposed by the NEF 1652 to other NFs and AFs, or used for other purposes such as analytics. Additionally, the NEF 1652 may exhibit an Nnef service-based interface.

The NRF 1654 may support service discovery functions, receive NF discovery requests from NF instances, and provide the information of the discovered NF instances to the NF instances. NRF 1654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1654 may exhibit the Nnrf service-based interface.

The PCF 1656 may provide policy rules to control plane functions to enforce them, and may also support unified policy framework to govern network behavior. The PCF 1656 may also implement a front end to access subscription information relevant for policy decisions in a UDR of the UDM 1658. In addition to communicating with functions over reference points as shown, the PCF 1656 exhibit an Npcf service-based interface.

The UDM 1658 may handle subscription-related information to support the network entities' handling of communication sessions, and may store subscription data of UE 1602. For example, subscription data may be communicated via an N8 reference point between the UDM 1658 and the AMF 1644. The UDM 1658 may include two parts, an application front end and a UDR. The UDR may store subscription data and policy data for the UDM 1658 and the PCF 1656, and/or structured data for exposure and application data (including PFDs for application detection, application request information for multiple UEs 1602) for the NEF 1652. The Nudr service-based interface may be exhibited by the UDR 221 to allow the UDM 1658, PCF 1656, and NEF 1652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1658 may exhibit the Nudm service-based interface.

The AF 1660 may provide application influence on traffic routing, provide access to NEF, and interact with the policy framework for policy control.

In some embodiments, the 5GC 1640 may enable edge computing by selecting operator/3^{rd} party services to be geographically close to a point that the UE 1602 is attached to the network. This may reduce latency and load on the network. To provide edge-computing implementations, the 5GC 1640 may select a UPF 1648 close to the UE 1602 and execute traffic steering from the UPF 1648 to data network 1636 via the N6 interface. This may be based on the UE subscription data, UE location, and information provided by the AF 1660. In this way, the AF 1660 may influence UPF (re) selection and traffic routing. Based on operator deployment, when AF 1660 is considered to be a trusted entity, the network operator may permit AF 1660 to interact directly with relevant NFs. Additionally, the AF 1660 may exhibit an Naf service-based interface.

The data network 1636 may represent various network operator services, Internet access, or third party services that may be provided by one or more servers including, for example, application/content server 1638.

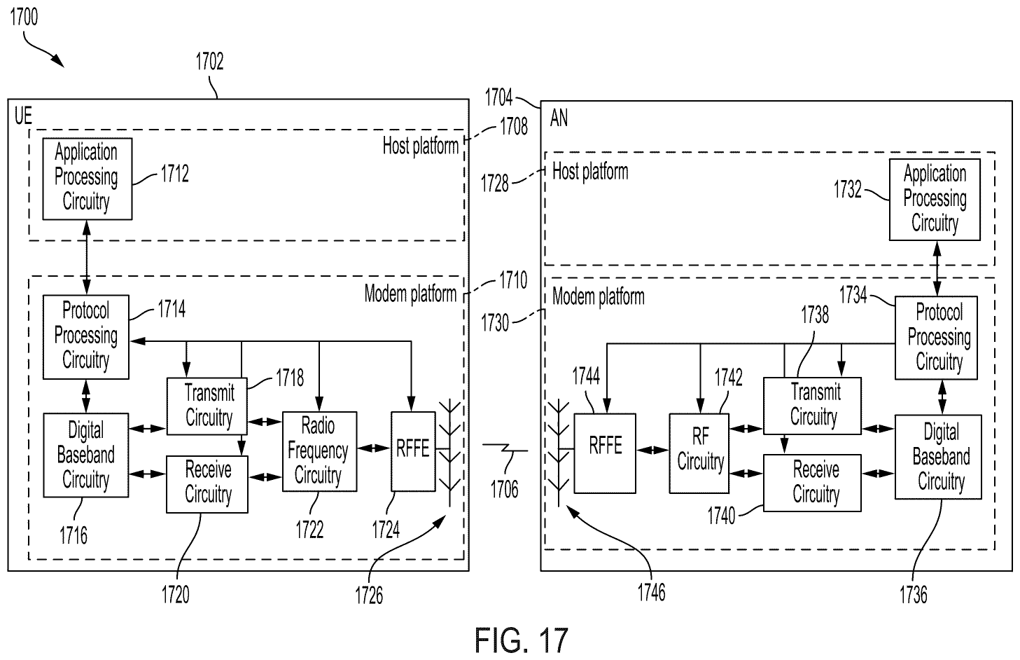

FIG. 17 schematically illustrates a cellular network 1700 in accordance with various embodiments. The cellular network 1700 may include a UE 1702 in wireless communication with an AN 1704. The UE 1702 and AN 1704 may be similar to, and substantially interchangeable with, like-named components described elsewhere herein.

The UE 1702 may be communicatively coupled with the AN 1704 via connection 1706. The connection 1706 is illustrated as an air interface to enable communicative coupling, and can be consistent with cellular communications protocols such as an LTE protocol or a 5G NR protocol operating at mmWave or sub-6 GHZ frequencies.

The UE 1702 may include a host platform 1708 coupled with a modem platform 1710. The host platform 1708 may include application processing circuitry 1712, which may be coupled with protocol processing circuitry 1714 of the modem platform 1710. The application processing circuitry 1712 may run various applications for the UE 1702 that source/sink application data. The application processing circuitry 1712 may further implement one or more layer operations to transmit/receive application data to/from a data network. These layer operations may include transport (for example UDP) and Internet (for example, IP) operations

The protocol processing circuitry 1714 may implement one or more of layer operations to facilitate transmission or reception of data over the connection 1706. The layer operations implemented by the protocol processing circuitry 1714 may include, for example, MAC, RLC, PDCP, RRC and NAS operations.

The modem platform 1710 may further include digital baseband circuitry 1716 that may implement one or more layer operations that are “below” layer operations performed by the protocol processing circuitry 1714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1710 may further include transmit circuitry 1718, receive circuitry 1720, RF circuitry 1722, and RF front end (RFFE) 1724, which may include or connect to one or more antenna panels 1726. Briefly, the transmit circuitry 1718 may include a digital-to-analog converter, mixer, intermediate frequency (IF) components, etc.; the receive circuitry 1720 may include an analog-to-digital converter, mixer, IF components, etc.; the RF circuitry 1722 may include a low-noise amplifier, a power amplifier, power tracking components, etc.; RFFE 1724 may include filters (for example, surface/bulk acoustic wave filters), switches, antenna tuners, beamforming components (for example, phase-array antenna components), etc. The selection and arrangement of the components of the transmit circuitry 1718, receive circuitry 1720, RF circuitry 1722, RFFE 1724, and antenna panels 1726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1714 may include one or more instances of control circuitry (not shown) to provide control functions for the transmit/receive components.

A UE reception may be established by and via the antenna panels 1726, RFFE 1724, RF circuitry 1722, receive circuitry 1720, digital baseband circuitry 1716, and protocol processing circuitry 1714. In some embodiments, the antenna panels 1726 may receive a transmission from the AN 1704 by receive-beamforming signals received by a plurality of antennas/antenna elements of the one or more antenna panels 1726.

A UE transmission may be established by and via the protocol processing circuitry 1714, digital baseband circuitry 1716, transmit circuitry 1718, RF circuitry 1722, RFFE 1724, and antenna panels 1726. In some embodiments, the transmit components of the UE 1704 may apply a spatial filter to the data to be transmitted to form a transmit beam emitted by the antenna elements of the antenna panels 1726.

Similar to the UE 1702, the AN 1704 may include a host platform 1728 coupled with a modem platform 1730. The host platform 1728 may include application processing circuitry 1732 coupled with protocol processing circuitry 1734 of the modem platform 1730. The modem platform may further include digital baseband circuitry 1736, transmit circuitry 1738, receive circuitry 1740, RF circuitry 1742, RFFE circuitry 1744, and antenna panels 1746. The components of the AN 1704 may be similar to and substantially interchangeable with like-named components of the UE 1702. In addition to performing data transmission/reception as described above, the components of the AN 1708 may perform various logical functions that include, for example, RNC functions such as radio bearer management, uplink and downlink dynamic radio resource management, and data packet scheduling.

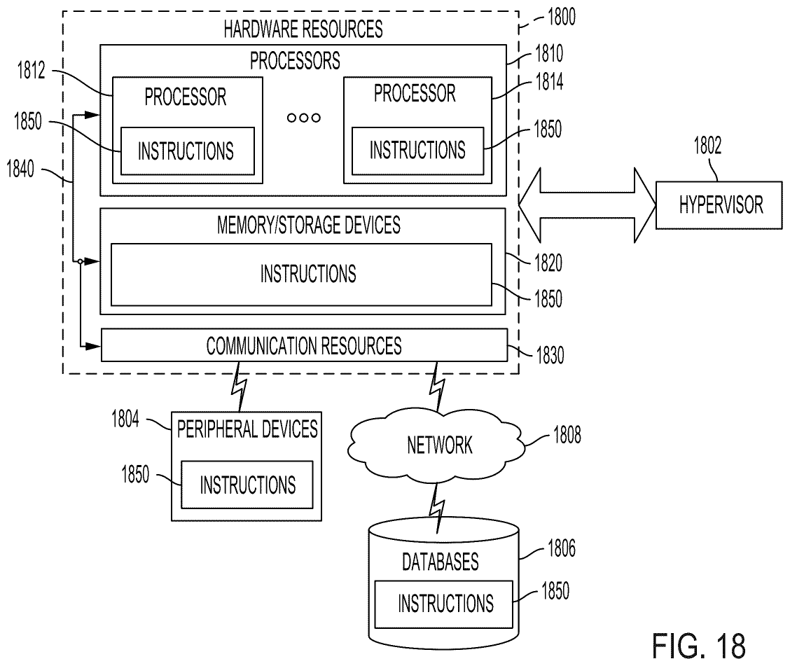

FIG. 18 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 18 shows a diagrammatic representation of hardware resources 1800 including one or more processors (or processor cores) 1810, one or more memory/storage devices 1820, and one or more communication resources 1830, each of which may be communicatively coupled via a bus 1840 or other interface circuitry. For embodiments where node virtualization (e.g., NFV) is utilized, a hypervisor 1802 may be executed to provide an execution environment for one or more network slices/sub-slices to utilize the hardware resources 1800.

The processors 1810 may include, for example, a processor 1812 and a processor 1814. The processors 1810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1820 may include main memory, disk storage, or any suitable combination thereof. The memory/storage devices 1820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1830 may include interconnection or network interface controllers, components, or other suitable devices to communicate with one or more peripheral devices 1804 or one or more databases 1806 or other network elements via a network 1808. For example, the communication resources 1830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1850 may comprise software, a program, an application, an applet, an app, or other executable code for causing at least any of the processors 1810 to perform any one or more of the methodologies discussed herein. The instructions 1850 may reside, completely or partially, within at least one of the processors 1810 (e.g., within the processor's cache memory), the memory/storage devices 1820, or any suitable combination thereof. Furthermore, any portion of the instructions 1850 may be transferred to the hardware resources 1800 from any combination of the peripheral devices 1804 or the databases 1806. Accordingly, the memory of processors 1810, the memory/storage devices 1820, the peripheral devices 1804, and the databases 1806 are examples of computer-readable and machine-readable media.

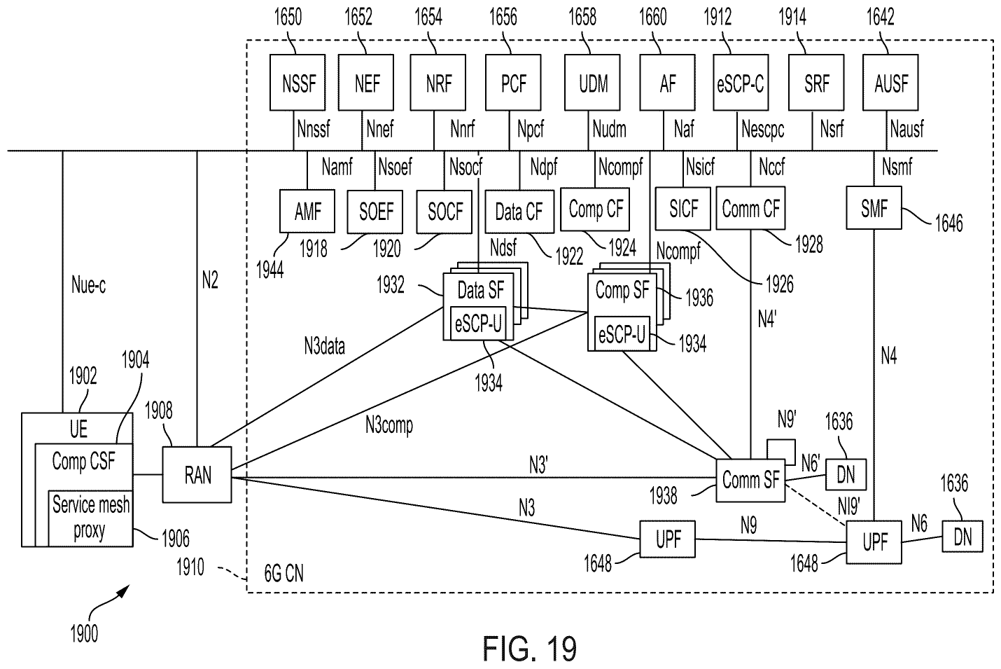

FIG. 19 illustrates a network 1900 in accordance with various embodiments. The network 1900 may operate in a matter consistent with 3GPP technical specifications or technical reports for 6G systems. In some embodiments, the network 1900 may operate concurrently with network 1600. For example, in some embodiments, the network 1900 may share one or more frequency or bandwidth resources with network 1600. As one specific example, a UE (e.g., UE 1902) may be configured to operate in both network 1900 and network 1600. Such configuration may be based on a UE including circuitry configured for communication with frequency and bandwidth resources of both networks 1600 and 1900. In general, several elements of network 1900 may share one or more characteristics with elements of network 1600. For the sake of brevity and clarity, such elements may not be repeated in the description of network 1900.

The network 1900 may include a UE 1902, which may include any mobile or non-mobile computing device designed to communicate with a RAN 1908 via an over-the-air connection. The UE 1902 may be similar to, for example, UE 1602. The UE 1902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 19, in some embodiments the network 1900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 19, the UE 1902 may be communicatively coupled with an AP such as AP 1606 as described with respect to FIG. 16. Additionally, although not specifically shown in FIG. 19, in some embodiments the RAN 1908 may include one or more ANss such as AN 1608 as described with respect to FIG. 16. The RAN 1908 and/or the AN of the RAN 1908 may be referred to as a base station (BS), a RAN node, or using some other term or name.

The UE 1902 and the RAN 1908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1908 may allow for communication between the UE 1902 and a 6G core network (CN) 1910. Specifically, the RAN 1908 may facilitate the transmission and reception of data between the UE 1902 and the 6G CN 1910. The 6G CN 1910 may include various functions such as NSSF 1650, NEF 1652, NRF 1654, PCF 1656, UDM 1658, AF 1660, SMF 1646, and AUSF 1642. The 6G CN 1910 may additional include UPF 1648 and DN 1636 as shown in FIG. 19.

Additionally, the RAN 1908 may include various additional functions that are in addition to, or alternative to, functions of a legacy cellular network such as a 4G or 5G network. Two such functions may include a Compute Control Function (Comp CF) 1924 and a Compute Service Function (Comp SF) 1936. The Comp CF 1924 and the Comp SF 1936 may be parts or functions of the Computing Service Plane. Comp CF 1924 may be a control plane function that provides functionalities such as management of the Comp SF 1936, computing task context generation and management (e.g., create, read, modify, delete), interaction with the underlying computing infrastructure for computing resource management, etc., Comp SF 1936 may be a user plane function that serves as the gateway to interface computing service users (such as UE 1902) and computing nodes behind a Comp SF instance. Some functionalities of the Comp SF 1936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1936 instance may serve as the user plane gateway for a cluster of computing nodes. A Comp CF 1924 instance may control one or more Comp SF 1936 instances.

Two other such functions may include a Communication Control Function (Comm CF) 1928 and a Communication Service Function (Comm SF) 1938, which may be parts of the Communication Service Plane. The Comm CF 1928 may be the control plane function for managing the Comm SF 1938, communication sessions creation/configuration/releasing, and managing communication session context. The Comm SF 1938 may be a user plane function for data transport. Comm CF 1928 and Comm SF 1938 may be considered as upgrades of SMF 1646 and UPF 1648, which were described with respect to a 5G system in FIG. 16. The upgrades provided by the Comm CF 1928 and the Comm SF 1938 may enable service-aware transport. For legacy (e.g., 4G or 5G) data transport, SMF 1646 and UPF 1648 may still be used.

Two other such functions may include a Data Control Function (Data CF) 1922 and Data Service Function (Data SF) 1932 may be parts of the Data Service Plane. Data CF 1922 may be a control plane function and provides functionalities such as Data SF 1932 management, Data service creation/configuration/releasing, Data service context management, etc. Data SF 1932 may be a user plane function and serve as the gateway between data service users (such as UE 1902 and the various functions of the 6G CN 1910) and data service endpoints behind the gateway. Specific functionalities may include include: parse data service user data and forward to corresponding data service endpoints, generate charging data, report data service status.

Another such function may be the Service Orchestration and Chaining Function (SOCF) 1920, which may discover, orchestrate and chain up communication/computing/data services provided by functions in the network. Upon receiving service requests from users, SOCF 1920 may interact with one or more of Comp CF 1924, Comm CF 1928, and Data CF 1922 to identify Comp SF 1936, Comm SF 1938, and Data SF 1932 instances, configure service resources, and generate the service chain, which could contain multiple Comp SF 1936, Comm SF 1938, and Data SF 1932 instances and their associated computing endpoints. Workload processing and data movement may then be conducted within the generated service chain. The SOCF 1920 may also responsible for maintaining, updating, and releasing a created service chain.

Another such function may be the service registration function (SRF) 1914, which may act as a registry for system services provided in the user plane such as services provided by service endpoints behind Comp SF 1936 and Data SF 1932 gateways and services provided by the UE 1902. The SRF 1914 may be considered a counterpart of NRF 1654, which may act as the registry for network functions.

Other such functions may include an evolved service communication proxy (eSCP) and service infrastructure control function (SICF) 1926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1912 and eSCP-U 1934, for control plane service communication proxy and user plane service communication proxy, respectively. The SICF 1926 may control and configure eCSP instances in terms of service traffic routing policies, access rules, load balancing configurations, performance monitoring, etc.

Another such function is the AMF 1944. The AMF 1944 may be similar to 1644, but with additional functionality. Specifically, the AMF 1944 may include potential functional repartition, such as move the message forwarding functionality from the AMF 1944 to the RAN 1908.

Another such function is the service orchestration exposure function (SOEF) 1918. The SOEF may be configured to expose service orchestration and chaining services to external users such as applications.

The UE 1902 may include an additional function that is referred to as a computing client service function (comp CSF) 1904. The comp CSF 1904 may have both the control plane functionalities and user plane functionalities, and may interact with corresponding network side functions such as SOCF 1920, Comp CF 1924, Comp SF 1936, Data CF 1922, and/or Data SF 1932 for service discovery, request/response, compute task workload exchange, etc. The Comp CSF 1904 may also work with network side functions to decide on whether a computing task should be run on the UE 1902, the RAN 1908, and/or an element of the 6G CN 1910.

The UE 1902 and/or the Comp CSF 1904 may include a service mesh proxy 1906. The service mesh proxy 1906 may act as a proxy for service-to-service communication in the user plane. Capabilities of the service mesh proxy 1906 may include one or more of addressing, security, load balancing, etc.

### Example Procedures

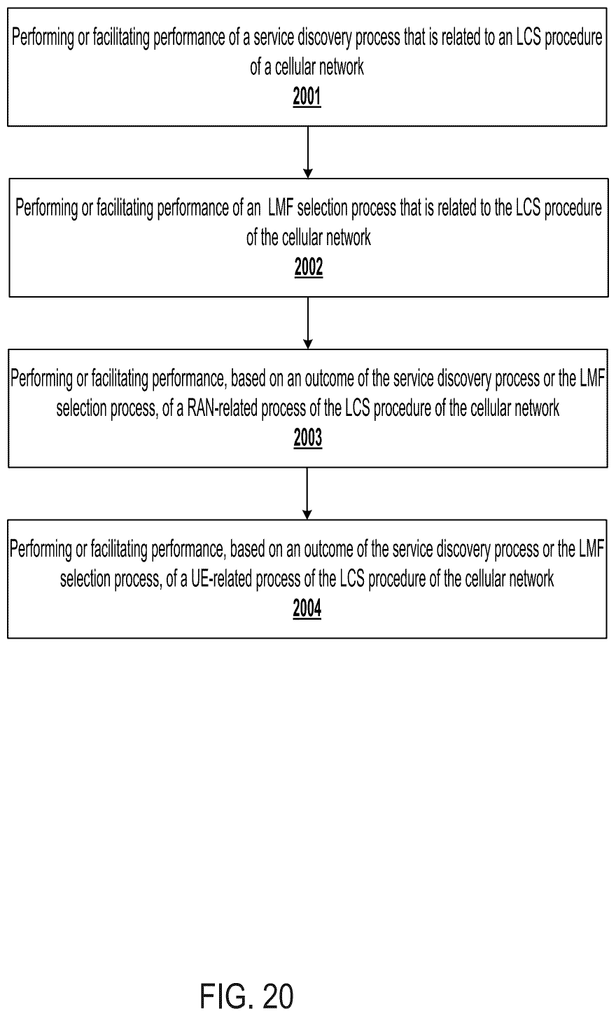

In some embodiments, the electronic device(s), network(s), system(s), chip(s) or component(s), or portions or implementations thereof, of FIGS. 16-19, or some other figure herein, may be configured to perform one or more processes, techniques, or methods as described herein, or portions thereof. One such process is depicted in FIG. 20. The process of FIG. 20 may include or relate to a method to be performed by one or more electronic devices of, or associated with, a cellular network. The process may include performing or facilitating performance, at 2001, of a service discovery process that is related to a location service (LCS) procedure of the cellular network; performing or facilitating performance, at 2002, of a location management function (LMF) selection process that is related to the LCS procedure of the cellular network; performing or facilitating performance, at 2003 based on an outcome of the service discovery process or the LMF selection process, of a radio access network (RAN)-related process of the LCS procedure of the cellular network; and/or performing or facilitating performance, at 2004 based on an outcome of the service discovery process or the LMF selection process, of a user equipment (UE)-related process of the LCS procedure of the cellular network.

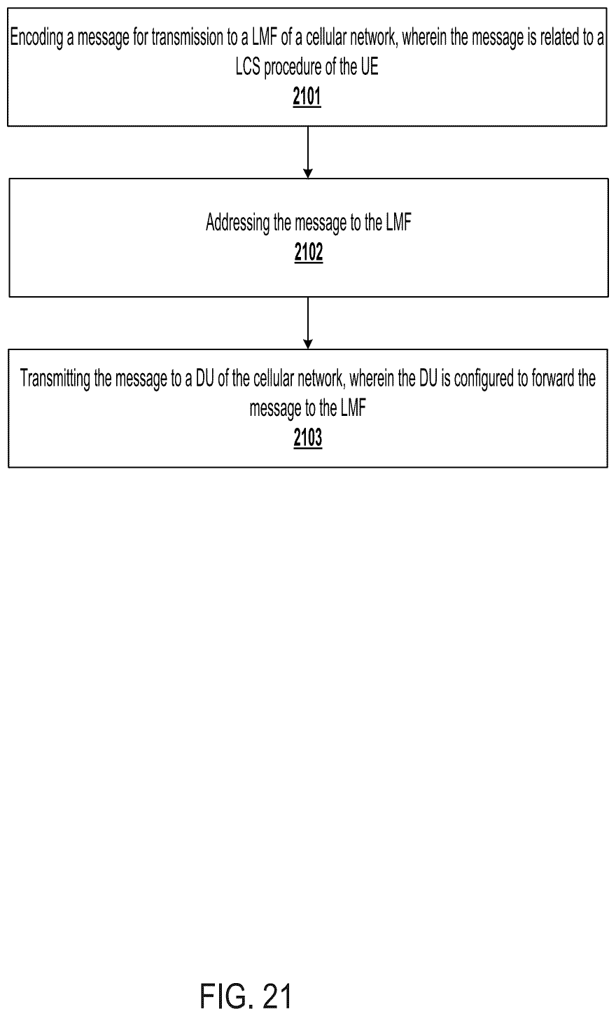

FIG. 21 depicts an alternative example procedure that may include or relate to a method to be performed by a user equipment (UE), one or more elements of a UE, and/or one or more electronic devices that include and/or implement a UE. The process may include encoding, at 2101, a message for transmission to a location mobility function (LMF) of a cellular network, wherein the message is related to a location service (LCS) procedure of the UE; addressing, at 2102, the message to the LMF; and transmitting, at 2103, the message to a distributed unit (DU) of the cellular network, wherein the DU is configured to forward the message to the LMF.

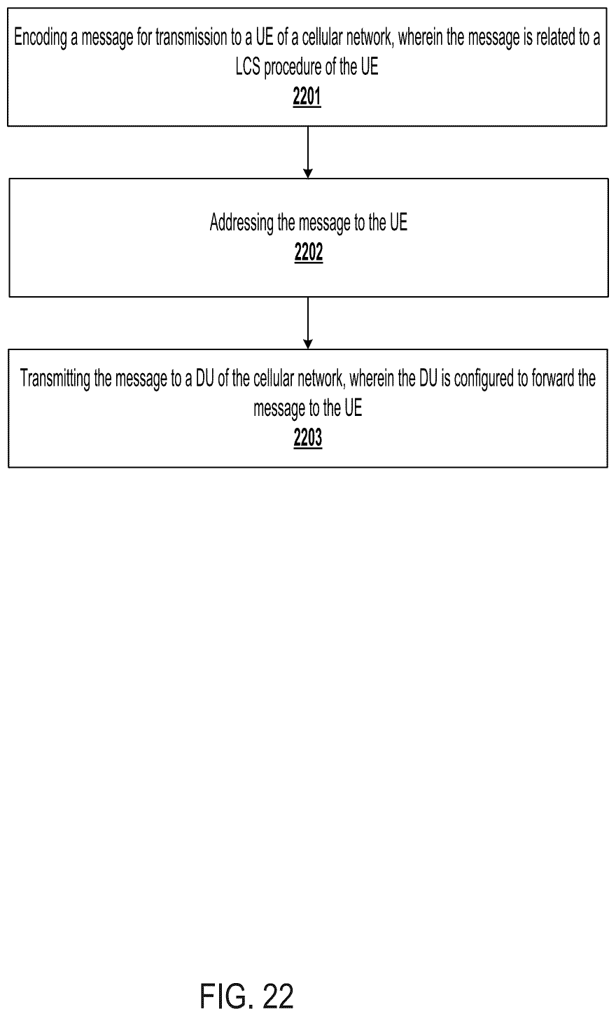

FIG. 22 depicts an alternative example procedure that may include or relate to a method to be performed by a location mobility function (LMF), one or more elements of an LMF, and/or one or more electronic devices that include and/or implement an LMF. The process may include encoding, at 2201, a message for transmission to a UE of a cellular network, wherein the message is related to a location service (LCS) procedure of the UE; addressing, at 2202, the message to the UE; and transmitting, at 2203, the message to a distributed unit (DU) of the cellular network, wherein the DU is configured to forward the message to the UE.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include the overall LCS procedure to include the service discovery and LMF selection process before the RAN related and UE related procedures

Example 2 may include the method of example 1 and/or some other example herein, wherein to enable LPP message exchange directly between UE and LMF via DU as the UE related procedure where the LCS correlation ID is allocated by RCM/AMF or LMF during the service discovery and LMF selection process and sent to DU during the network initiated service request procedure or a RRC_DLInfoTransfer message

Example 3 may include the method of example 2 and/or some other example herein, wherein that DU can uses the LCS correlation ID to identify the UE and the LMF to route the LPP PDU.

Example 4 may include the method of example 1 and/or some other example herein, wherein to enable LPP message exchange between DU and UE via RCM where the LCS correlation ID is allocated during the service discovery and LMF selection process by RCM/AMF or LMF and stored in the RCM.

Example 5 may include the method of example 4 and/or some other example herein, wherein to enable RCM to use the LCS correlation ID to identify the UE and the LMF to route the LPP PDU.

Example 6 may include the method of example 1 and/or some other example herein, wherein to enable UE specific NRPPa message directly between DU and LMF as the RAN related procedure where the DU+UE identifier and LMF identifier are used to replace the AMF UE NGAP ID and RAN UE NGAP ID. There are different embodiments for the DU+UE identifier and LMF identifier.

Example 7 may include the method of example 6 and/or some other example herein, wherein that the DU+UE identifier and the LMF identifier are stored in RCM/AMF and sent to the DU to identify the UE specific NRPPa message

Example 8 may include the method of Example 1 and/or some other example herein, wherein to enable UE specific NRPPa message directly between DU and LMF via RCM as the RAN related procedure where the DU+UE identifier and LMF identifier are used to replace the AMF UE NGAP ID and RAN UE NGAP ID. There are different embodiments for the DU+UE identifier and LMF identifier.

Example 9 may include the method of example 8 and/or some other example herein, wherein that the DU+UE identifier and the LMF identifier are stored in RCM/AMF to identify the UE specific NRPPa message

Example 10 may include the method of example 1 and/or some other example herein, wherein the non UE specific NRPPa message can be sent between DU or other RAN function and LMF using service discovery or configured by RCM to get the DU or other RAN function ID and LMF ID.

Example 11 may include or relate to a method to be performed by one or more electronic devices of, or associated with, a cellular network, wherein the method comprises: performing or facilitating performance of a service discovery process that is related to a location service (LCS) procedure of the cellular network; performing or facilitating performance of a location management function (LMF) selection process that is related to the LCS procedure of the cellular network; performing or facilitating performance, based on an outcome of the service discovery process or the LMF selection process, of a radio access network (RAN)-related process of the LCS procedure of the cellular network; and/or performing or facilitating performance, based on an outcome of the service discovery process or the LMF selection process, of a user equipment (UE)-related process of the LCS procedure of the cellular network.

Example 12 may include or relate to the method of example 11, and/or some other example herein, wherein the UE-related procedure is related to enabling message exchange between the UE and the LMF via a distributed unit (DU) of the cellular network.

Example 13 may include or relate to a method to be performed by a user equipment (UE), one or more elements of a UE, and/or one or more electronic devices that include and/or implement a UE, wherein the method comprises: generating a message for transmission to a location mobility function (LMF) of a cellular network, wherein the message is related to a location service (LCS) procedure of the UE; addressing the message to the LMF; and encoding the message for transmission to a distributed unit (DU) of the cellular network, wherein the DU is configured to forward the message to the LMF.

Example 14 may include or relate to the method of example 13, and/or one or more other examples herein, wherein the method further comprises addressing the message to the LMF to bypass an access mobility function (AMF) of the cellular network.

Example 15 may include or relate to the method of example 13, and/or one or more other examples herein, wherein the method further comprises addressing the message to the LMF to use a radio configuration manager (RCM) as a relay between the DU and the LMF.

Example 16 may include or relate to the method of example 15, and/or one or more other examples herein, wherein the RCM is related to an access mobility function (AMF) of the cellular network.

Example 17 may include or relate to the method of any one or more of examples 13-16, and/or one or more other examples herein, wherein the LCS procedure is related to long term evolution (LTE) positioning protocol (LPP).

Example 18 may include or relate to the method of any one or more of examples 13-17, and/or one or more other examples herein, wherein the LCS procedure is related to new radio (NR) positioning protocol A (NRPPa).

Example 19 may include or relate to the method of any one or more of examples 13-18, and/or one or more other examples herein, wherein: addressing the message to the LMF includes associating the message with an identifier (ID) of the LMF; and the ID of the LMF is an LMF function ID, an internet protocol (IP) address of the LMF, a port number of the LMF, or a uniform resource identifier (URI) of the LMF.

Example 20 may include or relate to a method to be performed by a location mobility function (LMF), one or more elements of an LMF, and/or one or more electronic devices that include and/or implement an LMF, wherein the method comprises: generating a message for transmission to a UE of a cellular network, wherein the message is related to a location service (LCS) procedure of the UE; addressing the message to the UE; and transmitting the message to a distributed unit (DU) of the cellular network, wherein the DU is configured to forward the message to the UE.

Example 21 may include or relate to the method of example 20, and/or one or more other examples herein, wherein the method further comprises addressing the message to the UE to bypass an access mobility function (AMF) of the cellular network.

Example 22 may include or relate to the method of example 20, and/or one or more other examples herein, wherein the method further comprises addressing the message to the UE to use a radio configuration manager (RCM) as a relay between the DU and the LMF.

Example 23 may include or relate to the method of example 22, and/or one or more other examples herein, wherein the RCM is related to an access mobility function (AMF) of the cellular network.

Example 24 may include or relate to the method of any one or more of examples 20-23, and/or one or more other examples herein, wherein the LCS procedure is related to long term evolution (LTE) positioning protocol (LPP).

Example 25 may include or relate to the method of example 24, and/or one or more other examples herein, wherein addressing the message includes a LCS correlation identifier (ID) associated with the LCS procedure and a LPP protocol data unit (PDU).

Example 26 may include or relate to the method of any one or more of examples 20-25, and/or one or more other examples herein, wherein the LCS procedure is related to new radio (NR) positioning protocol A (NRPPa).

Example 27 may include or relate to the method of any one or more of examples 20-26, and/or one or more other examples herein, wherein: addressing the message to the UE includes associating the message with an identifier (ID) that is associated with the UE and the DU; and the ID is based on a DU ID, an inactive radio network temporary identifier (I-RNTI) associated with the UE, an internet protocol (IP) address of the DU, an IP address of the UE, a port number of the DU, a uniform resource indicator (URI) of the DU, a URI of the UE, or a group ID that is associated with multiple DUs.

Example Z01 may include an apparatus comprising means to perform one or more elements of a method described in or related to any of examples 1-27, and/or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-27, and/or any other method or process described herein.

Example Z03 may include an apparatus comprising logic, modules, or circuitry to perform one or more elements of a method described in or related to any of examples 1-27, and/or any other method or process described herein.

Example Z04 may include a method, technique, or process as described in or related to any of examples 1-27, and/or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-27, and/or portions thereof.

Example Z06 may include a signal as described in or related to any of examples 1-27, or portions or parts thereof.

Example Z07 may include a datagram, packet, frame, segment, protocol data unit (PDU), or message as described in or related to any of examples 1-27, and/or portions or parts thereof, or otherwise described in the present disclosure.

Example Z08 may include a signal encoded with data as described in or related to any of examples 1-27, and/or portions or parts thereof, or otherwise described in the present disclosure.

Example Z09 may include a signal encoded with a datagram, packet, frame, segment, protocol data unit (PDU), or message as described in or related to any of examples 1-27, and/or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-27, and/or portions thereof.

Example Z11 may include a computer program comprising instructions, wherein execution of the program by a processing element is to cause the processing element to carry out the method, techniques, or process as described in or related to any of examples 1-27, and/or portions thereof.

Example Z12 may include a signal in a cellular network as shown and described herein.

Example Z13 may include a method of communicating in a cellular network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. An apparatus for use in a user equipment (UE), wherein the apparatus comprises:
memory to store information related to a location service (LCS) procedure of the UE; and
one or more processors configured to:
generate, based on the information, a message for transmission to a location mobility function (LMF) of a cellular network, wherein the message is related to the LCS procedure;
address the message to the LMF; and
encode the message for transmission to a distributed unit (DU) of the cellular network, wherein the DU is configured to forward the message to the LMF.

2. The apparatus of claim 1, wherein the one or more processors are further configured to address the message to the LMF to bypass an access mobility function (AMF) of the cellular network.

3. The apparatus of claim 1, wherein the one or more processors are further configured to address the message to the LMF to use a radio configuration manager (RCM) as a relay between the DU and the LMF.

4. The apparatus of claim 3, wherein the RCM is related to an access mobility function (AMF) of the cellular network.

5. The apparatus of claim 1, wherein the LCS procedure is related to long term evolution (LTE) positioning protocol (LPP).

6. The apparatus of claim 1, wherein the LCS procedure is related to new radio (NR) positioning protocol A (NRPPa).

7. The apparatus of claim 1, wherein:
addressing the message to the LMF includes associating the message with an identifier (ID) of the LMF; and
the ID of the LMF is an LMF function ID, an internet protocol (IP) address of the LMF, a port number of the LMF, or a uniform resource identifier (URI) of the LMF.

8. One or more non-transitory computer-readable media (NTCRM) comprising instructions that, upon execution of the instructions by one or more processors of an electronic device, are to cause a location mobility function (LMF) to:
generate a message for transmission to a UE of a cellular network, wherein the message is related to a location service (LCS) procedure of the UE;
address the message to the UE; and
encode the message for transmission to a distributed unit (DU) of the cellular network, wherein the DU is configured to forward the message to the UE.

9. The one or more NTCRM of claim 8, wherein the instructions are further to cause the LMF to address the message to the UE to bypass an access mobility function (AMF) of the cellular network.

10. The one or more NTCRM of claim 8, wherein the instructions are further to cause the LMF to address the message to the UE to use a radio configuration manager (RCM) as a relay between the DU and the LMF.

11. The one or more NTCRM of claim 10, wherein the RCM is related to an access mobility function (AMF) of the cellular network.

12. The one or more NTCRM of claim 8, wherein the LCS procedure is related to long term evolution (LTE) positioning protocol (LPP).

13. The one or more NTCRM of claim 12, wherein addressing the message includes a LCS correlation identifier (ID) associated with the LCS procedure and a LPP protocol data unit (PDU).

14. The one or more NTCRM of claim 8, wherein the LCS procedure is related to new radio (NR) positioning protocol A (NRPPa).

15. The one or more NTCRM of claim 8, wherein:
addressing the message to the UE includes associating the message with an identifier (ID) that is associated with the UE and the DU; and
the ID is based on a DU ID, an inactive radio network temporary identifier (I-RNTI) associated with the UE, an internet protocol (IP) address of the DU, an IP address of the UE, a port number of the DU, a uniform resource indicator (URI) of the DU, a URI of the UE, or a group ID that is associated with multiple DUs.

16. One or more non-transitory computer-readable media (NTCRM) comprising instructions that, upon execution of the instructions by one or more processors of an electronic device, are configured to cause a user equipment (UE) to:
generate a message for transmission to a location mobility function (LMF) of a cellular network, wherein the message is related to a location service (LCS) procedure of the UE;
address the message to the LMF; and
encode the message for transmission to a distributed unit (DU) of the cellular network, wherein the DU is configured to forward the message to the LMF.

17. The one or more NTCRM of claim 16, wherein the instructions are further to cause the UE to address the message to the LMF to bypass an access mobility function (AMF) of the cellular network.

18. The one or more NTCRM of claim 16, wherein the instructions are further to cause the UE to address the message to the LMF to use a radio configuration manager (RCM) as a relay between the DU and the LMF.

19. The one or more NTCRM of claim 16, wherein the LCS procedure is related to long term evolution (LTE) positioning protocol (LPP).

20. The one or more NTCRM of claim 16, wherein the LCS procedure is related to new radio (NR) positioning protocol A (NRPPa).
